(19) United States
(12) Patent Application Publication
(10) Pub. No.: US 2012/0059510 A1
(43) Pub. Date: Mar. 8, 2012

(54) MAINFRAME PREMOVE FOR A CLUSTER TOOL

(76) Inventors: Atsushi Kitani, Nara (JP); James Hoffman, San Jose, CA (US)

(21) Appl. No.: 12/877,043

(22) Filed: Sep. 7, 2010

(51) Int. Cl. G06F 7/00

(52) U.S. Cl. 700/228

(57) ABSTRACT

A method and system for a mainframe premove for a cluster tool is described herein. In one embodiment, the state of a process chamber which is to be used to run a process is obtained. A determination is made of whether the state of the process chamber indicates an almost ready state. A prepare command is sent to a transfer module if the state of the process chamber indicates the almost ready state. A transfer command is sent to the process chamber if the state of the process chamber indicates the almost ready state.

### TECHNICAL FIELD

Embodiments of the present invention relate to cluster tool efficiency, and more specifically to performing a mainframe premove for a cluster tool.

### BACKGROUND OF THE INVENTION

For many processes performed by a cluster tool, preheating glass is required to ensure high quality of a process using the glass. Glass is preheated in a preparation chamber and transferred to a process chamber, which performs a process using the glass. Typically, once the glass has been preheated, there are two ways in which the glass can be transferred from the preparation chamber to the process chamber: (1) full transfer and (2) half transfer.

In a full transfer of the glass, if the process chamber is not available at the time that the glass has finished preheating, the glass remains in the preparation chamber until the process chamber becomes available. When the process chamber becomes available, the glass is removed from the preparation chamber, placed into a transfer chamber, moved in front of the destination chamber, and placed into the destination chamber. The full transfer of the glass results in a loss of throughput equivalent to the time required to move the glass from the source chamber into the transfer chamber and to move the transfer chamber to be located in front of the process chamber. In one example, if the time to move the glass from the source chamber to the transfer chamber is thirty seconds and the time to move the transfer chamber is ten seconds, the throughput loss is forty seconds.

In a half transfer of the glass, the glass is preheated in the preparation chamber and removed from the preparation chamber once it has finished preheating. The glass is placed in the transfer chamber where it is held until the process chamber is available. Once the process chamber becomes available, the transfer chamber is moved to be in front of the process chamber and placed into the process chamber. The half transfer of the glass results in a loss of throughput equivalent to the time required to move the glass in front of the process chamber. Furthermore, additional throughput may be lost from the glass losing heat in the transfer chamber because the transfer chamber is not heated. The glass may therefore need to be reheated in the process chamber. In one example, if the time to move the transfer chamber is ten seconds, then the throughput loss is ten seconds. In this example, if the glass suffered heat loss while in the transfer chamber, and the time to reheat the glass is twenty seconds, the total throughput loss is thirty seconds.

### BRIEF DESCRIPTION OF THE DRAWINGS

The present invention is illustrated by way of example, and not by way of limitation, in the figures of the accompanying drawings and in which:

FIG. 1 illustrates an exemplary cluster tool on which embodiments of the present invention may be implemented;

FIG. 2 illustrates an embodiment of a mainframe premove system;

FIG. 3 illustrates a flow diagram of a mainframe premove method in accordance with embodiments of the present invention;

FIG. 4 illustrates a flow diagram of a state information update method in accordance with embodiments of the present invention;

FIG. 5 illustrates a state diagram of an update to state information in accordance with embodiments of the present invention; and

FIG. 6 illustrates an exemplary computer system.

### DETAILED DESCRIPTION

Embodiments of the invention are directed to a method and system for a mainframe premove for a cluster tool. The state of a process chamber to be used to run a process is obtained. A determination is made of whether the state of the process chamber indicates an almost ready state. A prepare command is sent to a transfer module if the state of the process chamber indicates the almost ready state. Furthermore, a transfer command is sent to the process chamber if the state of the process chamber indicates the almost ready state.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “identifying”, “comparing”, “sending”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relates to an apparatus for performing the operations herein. This apparatus can be specially constructed for the required purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, embodiments of the present invention are not described with reference to any particular programming language. It will be appreciated that a variety of programming languages can be used to implement the teachings of the invention as described herein.

A machine-readable storage medium can include any mechanism for storing information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

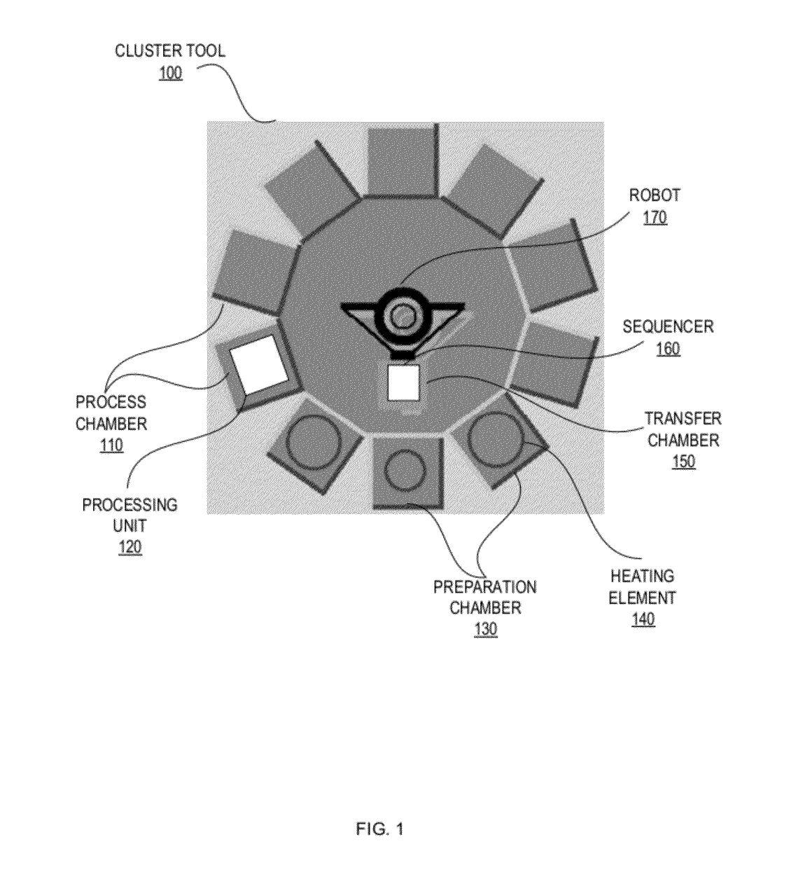

FIG. 1 illustrates an exemplary cluster tool on which embodiments of the present invention may be implemented. In one embodiment, cluster tool 100 can be a manufacturing tool running one or more processes which use glass. Cluster tool 100 includes one or more process chambers 110, one or more preparation chambers 130, and transfer chamber 150. Sequencer 160 can control the operations of all preparation chambers 130 and transfer chamber 150. Preparation chamber 130 prepares the glass for a process performed by cluster tool 100. In one embodiment, preparation chamber 130 is a heating chamber, and can include heating element 140 that heats up glass to a desired temperature for a process performed by cluster tool 100. Transfer chamber 150 can receive the prepared glass from preparation chamber 130. Transfer chamber 150 can include robot 170. Robot 170 can rotate transfer chamber 150 from preparation chamber 130 to another chamber in cluster tool 100, such as process chamber 110. Process chamber 110 can receive the glass and perform a process using the glass. Each process chamber 110 can include a processing unit 120 to control the operations of process chamber 110.

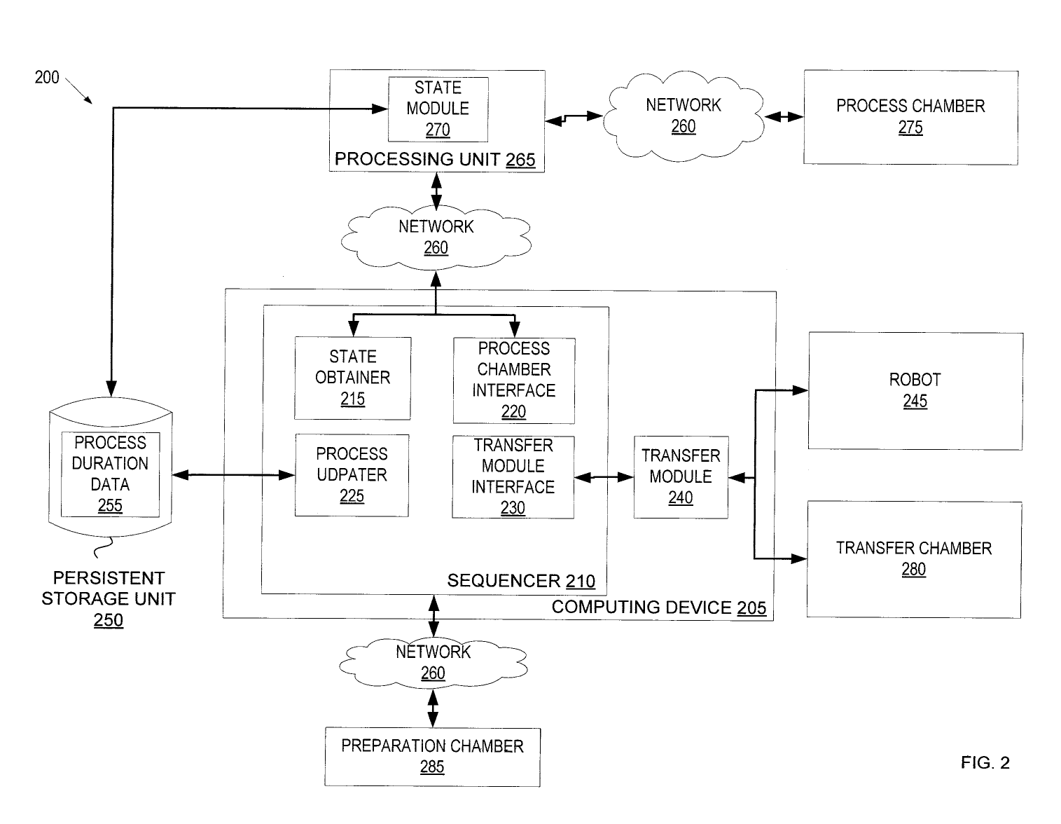

FIG. 2 illustrates one embodiment of a mainframe premove system 200. In one embodiment, mainframe premove system 200 is used in the manufacturing of display devices or solar devices. The display or solar devices can be manufactured in a factory using nano manufacturing technology. Manufacturing such devices generally includes the use of glass. Alternatively, the mainframe premove system 200 can be used in the manufacture of other products (e.g., automobiles), which may also include preparation of an element used in the manufacturing process.

Mainframe premove system 200 can include computing device 205, robot 245, persistent storage unit 250, processing unit 265, process chamber 275, transfer chamber 280, and preparation chamber 285. Mainframe premove system 200 can include chambers in addition to or different from process chamber 275, transfer chamber 280, and preparation chamber 285.

Computing device 205 can be any type of computing device including desktop computers, laptop computers, handheld computers, workstations, or similar computing device. In one embodiment, computing device 205 can connect to robot 245 and transfer chamber 280 via transfer module 240. In an alternate embodiment, robot 245 is a part of transfer module 240 and computing device 205 can therefore directly communicate with robot 245. Computing device 205 can communicate with preparation chamber 285 over network 260. In one embodiment, computing device 205 can issue Remote Procedure Call (RPC) commands to preparation chamber 285 over network 260. Network 260 can be a local area network (LAN), such as an intranet within a company, a wireless network, a mobile communications network, a wide area network (WAN), such as the Internet or similar communication system. Network 260 can include any number of networking and computing devices such as wired and wireless devices. Processing unit 265 can be any type of computing device including desktop computers, laptop computers, handheld computers or similar computing device. Processing unit 265 can communicate with process chamber 275 over network 260. In one embodiment, processing unit 265 can issue RPC commands to process chamber 275 over network 260. Computing device 205 can communicate with processing unit 265 over network 260. In one embodiment, computing device 205 can issue RPC commands to processing unit 265 over network 260.

Computing device 205 may contain sequencer 210 and transfer module 240. Sequencer 210 may contain state obtainer 215, process chamber interface 220, process updater 225, and transfer module interface 230. This division of functionality is presented by way of example for sake of clarity. One skilled in the art would understand that the functionality described could be combined into a monolithic component or sub-divided into any combination of components. Sequencer 210 and transfer module 240 can be hosted on a single computer system, such as computing device 205, on separate computer systems, or on a combination thereof.

Sequencer 210 can control the operations of preparation chamber 285, such as preheating glass and opening the preparation chamber. Transfer module 240 can send commands to robot 245 to control the movements of robot 245, such as causing robot 245 to rotate. Transfer module 240 can further send commands to transfer chamber 280 to control the operations of transfer chamber 280, such as obtaining glass from preparation chamber 285 and opening transfer chamber 280. Processing until 265 can send commands to process chamber 275 to control the operations of process chamber 275, such as opening process chamber 275 and receiving glass from transfer chamber 280. In one embodiment, transfer chamber 280 is attached or coupled to robot 245, such that robot 245 can be used to move transfer chamber 280. For example, transfer module 240 can send a command to preparation chamber 285 to preheat glass located inside preparation chamber 285. Transfer module can further send a command to robot 245 to move transfer chamber 280 in front of process chamber 275. Following the move of transfer chamber 280, transfer module 240 can issue a command to transfer chamber 280 to open transfer chamber 280 and remove glass that was inside of transfer chamber 280. Processing unit 265 can send a command to process chamber 275 to open process chamber 275 and accept the glass from transfer module 280.

State obtainer 215 can obtain state information from processing unit 265 that can be used to determine if process chamber 275 is almost ready to begin executing a next process (i.e., is in an almost ready state indicating that process chamber 275 is scheduled to complete a current process in a short time interval). Once process chamber 275 has completed a process, process updater 225 can send information to persistent storage unit 250 about a duration of the process. Persistent storage unit 250 can store process duration data 255. Process duration data 255 can include data about one or more processes performed by process chamber 275. If the state is an almost ready state, transfer module interface 230 can send a prepare command to transfer module 240, which transfer module 240 can use to turn robot 245 and prepare transfer chamber 280 to transfer glass to process chamber 275. If the state is the almost ready state, process chamber interface 220 can send a command to transfer module 240 to prepare process chamber 275 to receive glass from transfer chamber 280.

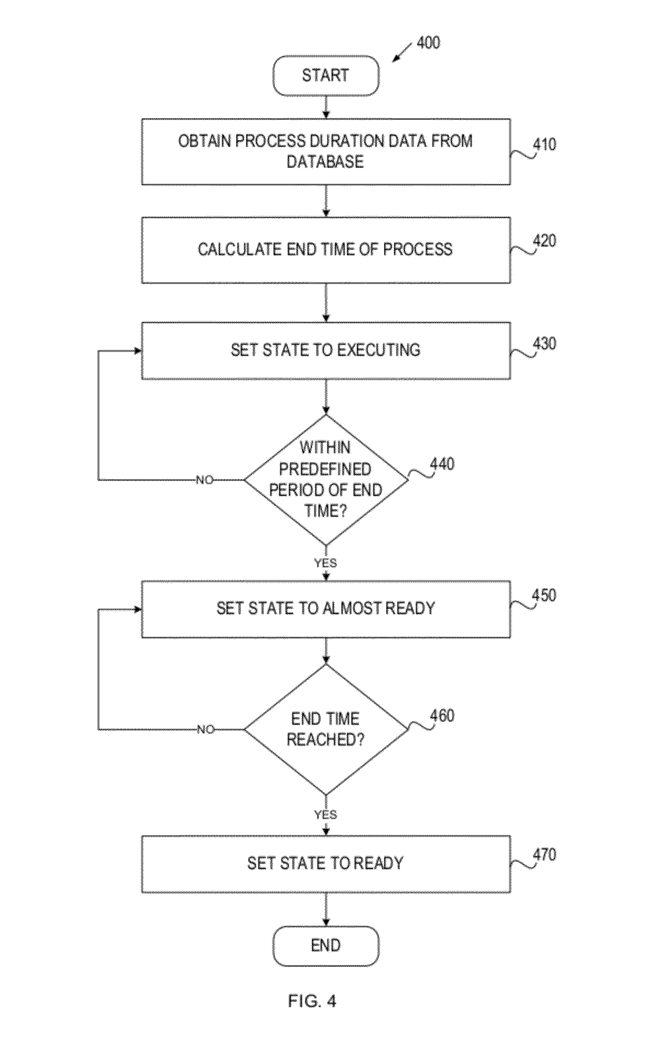

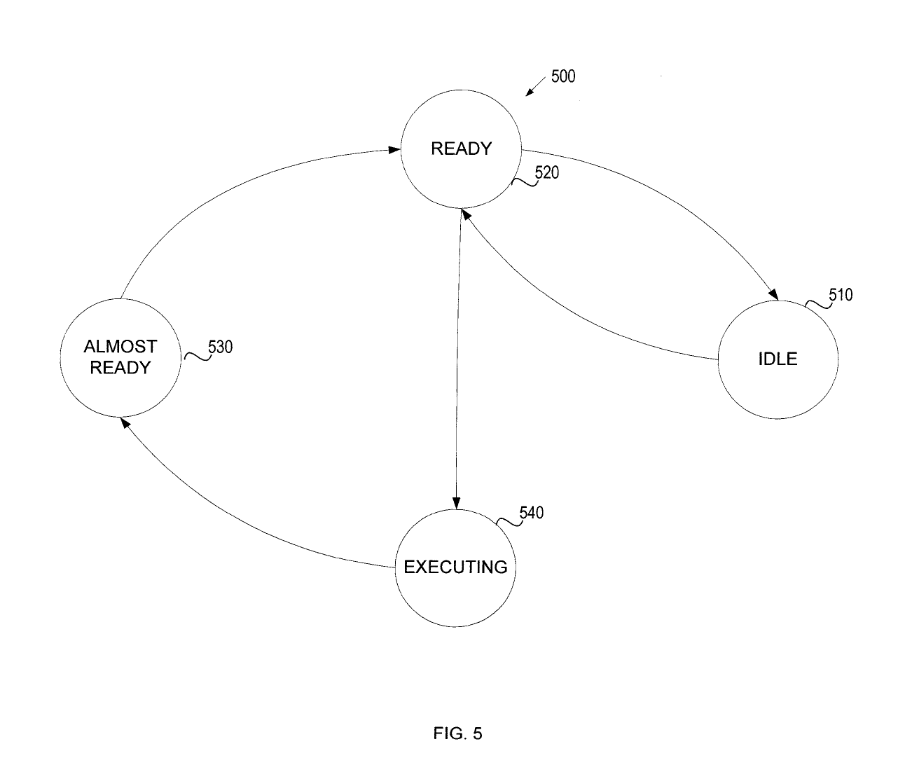

State module 270 in processing until 265 can update state information for process chamber 275 based on the portion of the process that process chamber 275 is executing. In one embodiment, state module 270 obtains process duration data 255 from persistent storage unit 250 and uses process duration data 255 in determining the state of process chamber 275. The updating of state information is further described below in conjunction with FIG. 4 and FIG. 5.

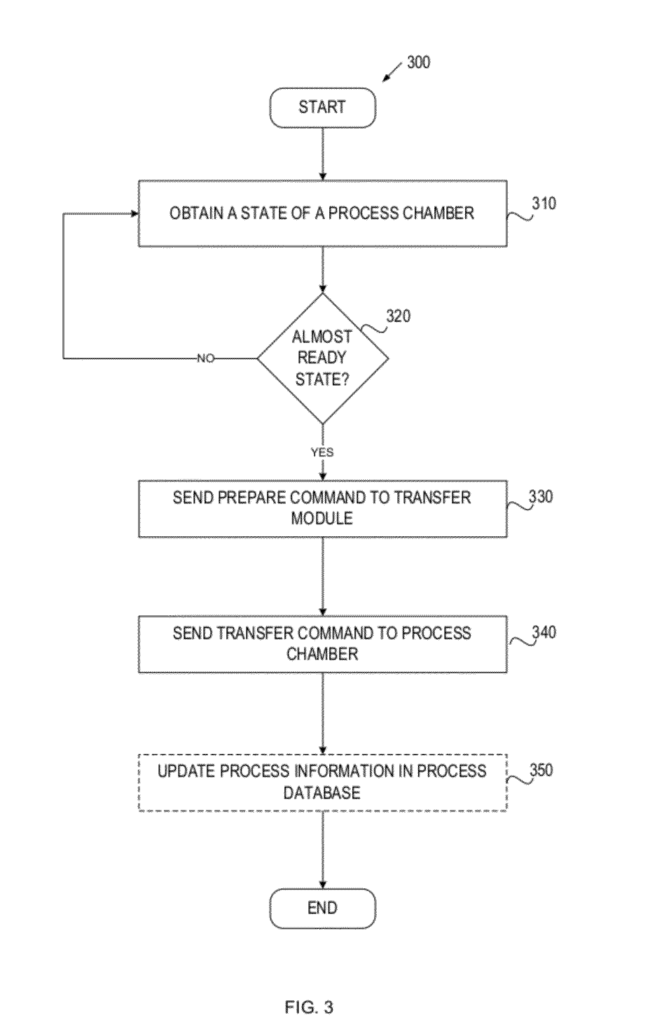

FIG. 3 illustrates one embodiment of a method 300 for a mainframe premove. Method 300 can be performed by processing logic that can comprise hardware (e.g., circuitry, dedicated logic, programmable logic, microcode, etc.), software (e.g., instructions run on a processing device), or a combination thereof. In one embodiment, method 300 is performed by sequencer 210 of FIG. 2.

At block 310, the state of a process chamber is obtained. The process chamber may next perform a process using glass that is currently in a preparation chamber or a transfer chamber in a cluster tool. In one embodiment, the state of the process chamber is obtained by polling the process chamber and requesting the state from the process chamber. In an alternate embodiment, the state of the process chamber is obtained by receiving state information from the process chamber at predefined intervals of time.

At block 320, processing logic determines if the state of the process chamber is an almost ready state. If the process chamber is not in the almost ready state, method 300 returns to block 310 where the state of the process chamber is obtained again. In one embodiment, if the state is obtained by polling the process chamber, processing logic waits a predetermined amount of time prior to obtain the state of the process chamber. For example, the state of the process chamber is obtained by polling the process chamber every second or every ten seconds. In one embodiment, the predetermined amount of time is configurable by a user. In an alternate embodiment, the predetermined amount of time is based on the process currently being run, the robot transfer speed, or other system factors of the cluster tool. If the process chamber is in the almost ready state, the process proceeds to block 330.

At block 330, a prepare command is sent to a transfer module. The prepare command indicates to the transfer module that the process chamber is almost ready to begin the next process. In one embodiment, in response to the prepare command, the transfer module can cause a preparation chamber to open and move the glass for the next process into the transfer chamber. In response to the prepare command, the transfer module can cause a robot in the cluster tool to turn such that the transfer chamber attached to the robot is in front of the process chamber. Furthermore, in one embodiment, in response to the prepare command, the transfer module can cause the transfer chamber to open.

At block 340, a transfer command is sent to the process chamber. In response to the transfer command, the process chamber can open to receive the glass from the transfer chamber.

At block 350, process information stored in a process database is updated. The duration of a process is updated for a process that completed in the process chamber. The duration of the process is used by a process chamber to determine a state of the process chamber, as described below in conjunction with FIG. 4 and FIG. 5. In certain embodiments, block 350 is optional and is not performed. In certain embodiments, if block 350 is omitted, method 300 ends after block 340 is performed.

FIG. 4 illustrates one embodiment of a method 400 for updating state information of a process chamber in a cluster tool. Method 400 can be performed by processing logic that can comprise hardware (e.g., circuitry, dedicated logic, programmable logic, microcode, etc.), software (e.g., instructions run on a processing device), or a combination thereof. In one embodiment, method 400 is performed by state module 270 of FIG. 2.

At block 410, process duration data is obtained from a database. The process duration data indicates the duration of the process when it was previously run in the mainframe system. In one embodiment, the duration of the process is based on the last run of the process. In an alternate embodiment, the duration of the process is an average of previous durations of the process run on the process chamber. In yet another embodiment, the duration of the process is an average of previous durations of the process run across all process chambers in the mainframe system.

At block 420, an end time of the process is calculated. In one embodiment, the end time of the process is calculated to be the sum of the duration of the process and the start time of the process. For example, if a process begins at 2:00 PM and the duration of the process is six minutes, the end time of the process is 2:06 PM. In an alternate embodiment, the end time of the process is the duration of the process. For example, if the duration of the process is six minutes, the end time is six minutes and a timer can be started to count the duration.

At block 430, the state of the process chamber is set to an executing state. The executing state indicates that the process is currently being performed by the process chamber.

At block 440, processing logic determines if the process is within a predefined period of the end time of the process. In one embodiment, the predefined period of time is based on a user configuration. In an alternate embodiment, the predefined period of time is calculated automatically based on the robot turn speed, robot transfer speed, or other system factors of the cluster tool. If the process is not within the predefined period of the end time of the process, method 400 returns to block 430 and the state of the process remains set to the executing state. In one embodiment, processing logic waits a predetermined amount of time prior to checking again whether the process is within a predefined period of the end time. In one embodiment, the predetermined amount of time is configured by a user. In an alternate embodiment, the predetermined amount of time is set to a default value, such as five seconds. If the process is within the predefined period of the end time of the process, method 400 proceeds to block 450. In one embodiment, the predefined period of the end time of the process is set to the sum of the time it takes the mainframe system to move the glass from the preparation chamber to the transfer chamber and the time it takes the mainframe system to rotate from the preparation chamber to the process chamber.

At block 450, the state of the process chamber is set to almost ready. The almost ready state indicates that the process has almost completed and that the process chamber will be able to begin another process soon.

At block 460, processing logic determines if the end time of the process has been reached. If the end time has not been reached, the process returns to block 450 and the state of the process chamber remains set to almost ready. In one embodiment, processing logic waits a predetermined amount of time prior to determining whether the end time of the process has been reached. If the end time has been reached, method 400 proceeds to block 470.

At block 470, the state of the process chamber is set to ready. The ready state indicates that the process has completed and that the process chamber is ready to begin another process.

FIG. 5 illustrates one embodiment of a state diagram 500 to update state information of a process chamber in a mainframe system. State diagram 500 can be performed by processing logic that can comprise hardware (e.g., circuitry, dedicated logic, programmable logic, microcode, etc.), software (e.g., instructions run on a processing device), or a combination thereof. In one embodiment, state diagram 500 is performed by state module 270 of FIG. 2.

Referring to FIG. 5, a state of a process chamber is initially set to “idle” 510. If the process chamber is not available to perform a process, then the state of the process chamber is idle. In one embodiment, the state of the process chamber is idle when the process chamber is offline. Once the process chamber is ready to perform a process, the state of the process chamber is updated from “idle” 510 to “ready” 520. In one embodiment, the state of the process chamber is ready when the process chamber is online and ready to perform a process, but has not started performing a process.

When the process chamber begins to execute a process, the state of the process chamber is updated from “ready” 520 to “executing” 540. When the process chamber is within a predefined period of the end time of the process currently executing, the state of the process chamber is updated from “executing” 540 to “almost ready” 530. In one embodiment, the predefined period of the end time of the process is set to the sum of the time it takes the cluster tool to move the glass from the preparation chamber to the transfer chamber and the time it takes the cluster tool to rotate from the preparation chamber to the process chamber. In an alternate embodiment, the predefined period of end time is defined by a user of the cluster tool. Once the process chamber has reached the end time of the process that was executing, the state of the process chamber is updated from “almost ready” 530 to “ready” 520. In one embodiment, the state of the process chamber is updated from “ready” 520 to “idle” 510 when the process chamber is taken offline or is not available. In an alternate embodiment, the state of the process chamber is updated from “ready” 520 to “idle” 510 when the process chamber is not ready to perform a process.

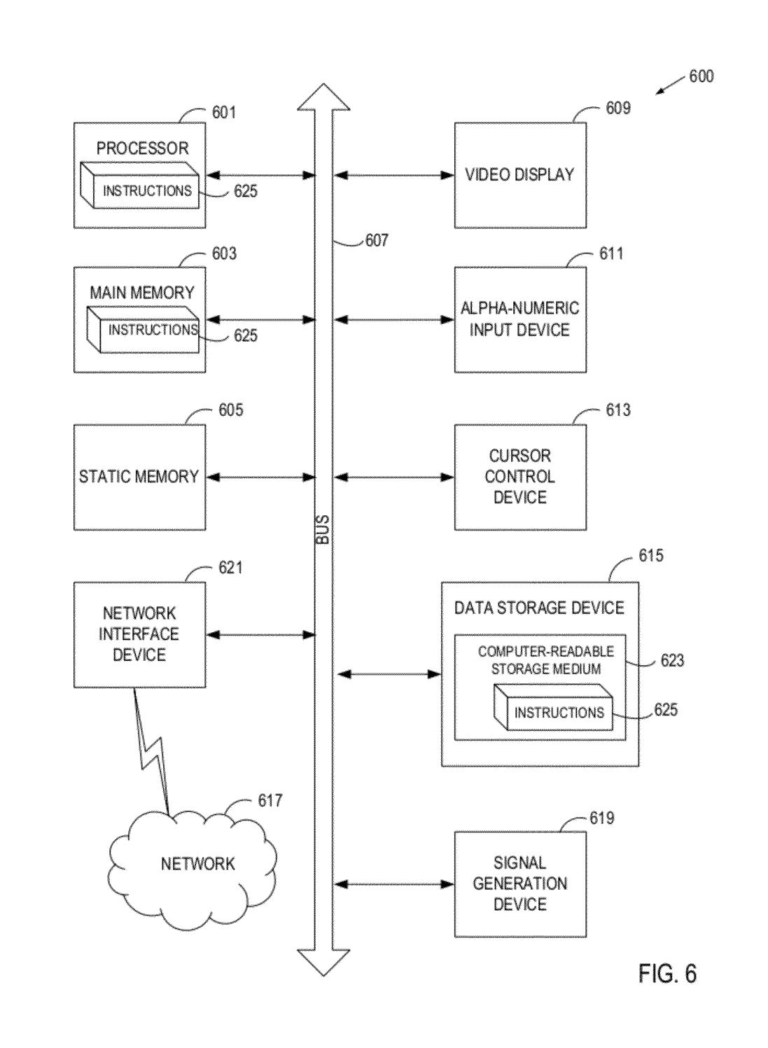

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device (processor) 601, a main memory 603 (e.g., read-only memory (ROM), flash memory, dynamic random access memory (DRAM) such as synchronous DRAM (SDRAM) or Rambus DRAM (RDRAM), etc.), a static memory 605 (e.g., flash memory, static random access memory (SRAM), etc.), and a data storage device 615 (e.g., drive unit), which communicate with each other via a bus 607.

The processor 601 represents one or more general-purpose processing devices such as a microprocessor, central processing unit, or the like. More particularly, the processor 601 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 601 may also be one or more special-purpose processing devices such as an application specific integrated circuit (ASIC), a field programmable gate array (FPGA), a digital signal processor (DSP), network processor, or the like. The processor 601 is configured to execute the instructions 625 for performing the operations and steps discussed herein.

The computer system 600 may further include a network interface device 621. The computer system 600 also may include a video display unit 609 (e.g., a liquid crystal display (LCD) or a cathode ray tube (CRT)), an alphanumeric input device 611 (e.g., a keyboard), a cursor control device 613 (e.g., a mouse), and a signal generation device 619 (e.g., a speaker).

The data storage device 615 may include a computer-readable storage medium 623 on which is stored one or more sets of instructions 625 (e.g., software) embodying any one or more of the methodologies or functions described herein. The instructions 625 may also reside, completely or at least partially, within the main memory 603 and/or within the processor 601 during execution thereof by the computer system 600, the main memory 603 and the processor 601 also constituting computer-readable storage media. The instructions 625 may further be transmitted or received over a network 617 via the network interface device 621.

The computer-readable storage medium 623 may also be used to store data structure sets that define user identifying states and user preferences that define user profiles. Data structure sets and user profiles may also be stored in other sections of computer system 600, such as static memory 605.

While the computer-readable storage medium 623 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories and optical and magnetic media.

It is to be understood that the above description is intended to be illustrative, and not restrictive. Many other embodiments will be apparent to those of skill in the art upon reading and understanding the above description.

What is claimed is:

1. A computer-implemented method comprising:
obtaining, by a computing device, a state of a process chamber;
determining, by the computing device, whether the state of the process chamber indicates an almost ready state;
sending a prepare command to a transfer module if the state of the process chamber indicates the almost ready state; and
sending a transfer command to the process chamber if the state of the process chamber indicates the almost ready state.

2. The computer-implemented method of claim 1, further comprising:
updating process information of a process run by the process chamber once the process has completed.

3. The computer-implemented method of claim 1, wherein the state of the process chamber is any one of an executing state, a ready state, an almost ready state, and an idle state.

4. The computer-implemented method of claim 3, wherein the state of the process chamber is changed from the executing state to the almost ready state when a process executed by the process chamber will complete in a predefined amount of time.

5. The computer-implemented method of claim 3, wherein the state of the process chamber is changed from the almost ready state to the ready state when a process executed by the process chamber has completed.

6. The computer-implemented method of claim 4, wherein the predefined amount of time is based on at least one of a time to move a preparation chamber to be located in front of a transfer chamber and a time to move an item from the preparation chamber to the transfer chamber.

7. The computer-implemented method of claim 1, wherein the prepare command causes the transfer module to move an item from a preparation chamber to a transfer chamber.

8. The computer-implemented method of claim 1, wherein the prepare command causes the transfer module to move a transfer chamber to be located in front of the process chamber.

9. The computer-implemented method of claim 1, wherein the transfer command causes the process chamber to open to accept an item from a transfer chamber.

10. A computer-readable storage medium comprising executable instructions to cause a processor to perform operations, the instructions comprising:
obtaining, by a computing device, a state of a process chamber;
determining, by the computing device, whether the state of the process chamber indicates an almost ready state;
sending a prepare command to a transfer module if the state of the process chamber indicates the almost ready state; and
sending a transfer command to the process chamber if the state of the process chamber indicates the almost ready state.

11. The computer-readable storage medium of claim 10, wherein the instructions further comprise:
updating process information of a process run by the process chamber once the process has completed.

12. The computer-readable storage medium of claim 10, wherein the state of the process chamber is any one of an executing state, a ready state, an almost ready state, and an idle state.

13. The computer-readable storage medium of claim 12, wherein the state of the process chamber is changed from the executing state to the almost ready state when a process executed by the process chamber will complete in a predefined amount of time.

14. The computer-readable storage medium of claim 12, wherein the state of the process chamber is changed from the almost ready state to the ready state when a process executed by the process chamber has completed.

15. The computer-readable storage medium of claim 13, wherein the predefined amount of time is based on at least one of a time to move a preparation chamber to be located in front of a transfer chamber and a time to move an item from the preparation chamber to the transfer chamber.

16. The computer-readable storage medium of claim 10, wherein the prepare command causes the transfer module to move an item from a preparation chamber to a transfer chamber and to move a transfer chamber to be located in front of the process chamber.

17. The computer-readable storage medium of claim 10, wherein the transfer command causes the process chamber to open to accept an item from a transfer chamber.

18. A computer system comprising:
a memory; and
a processor configurable by instructions stored in the memory to:
obtain, by a computing device, a state of a process chamber;
determine, by the computing device, whether the state of the process chamber indicates an almost ready state;
send a prepare command to a transfer module if the state of the process chamber indicates the almost ready state; and
send a transfer command to the process chamber if the state of the process chamber indicates the almost ready state.

19. The computer system of claim 18, wherein the processor is further configurable to:
update process information of a process run by the process chamber once the process has completed.

20. The computer system of claim 18, wherein the state of the process chamber is any one of an executing state, a ready state, an almost ready state, and an idle state.

21. The computer system of claim 20, wherein the state of the process chamber is changed from the executing state to the almost ready state when a process executed by the process chamber will complete in a predefined amount of time.

22. The computer system of claim 20, wherein the state of the process chamber is changed from the almost ready state to the ready state when a process executed by the process chamber has completed.

23. The computer system of claim 21, wherein the predefined amount of time is based on at least one of a time to move a preparation chamber to be located in front of a transfer chamber and a time to move an item from the preparation chamber to the transfer chamber.

24. The computer system of claim 18, wherein the prepare command causes the transfer module to move an item from a preparation chamber to a transfer chamber and to move a transfer chamber to be located in front of the process chamber.

25. The computer system of claim 18, wherein the transfer command causes the process chamber to open to accept an item from a transfer chamber.
